(19) United States
(12) Patent Application Publication
(10) Pub. No.: US 2009/0260293 A1
(43) Pub. Date: Oct. 22, 2009

(54) SAFETY GATE

(76) Inventor: Howard George LOUGH, Cornwall (CA)

Correspondence Address: OGILVY RENAULT LLP, 1, Place Ville Marie, SUITE 2500, MONTREAL, QC, H3B 1R1, CA

(21) Appl. No.: 12/423,868

(22) Filed: Apr. 15, 2009

Related U.S. Application Data
(60) Provisional application No. 61/046,084, filed on Apr. 18, 2008.

(51) Int. Cl. E05F 15/00; E05D 15/00

(52) U.S. Cl. 49/358; 49/402

(57) ABSTRACT

A safety gate includes an anchoring bracket for anchoring the safety gate to an immovable structure adjacent to a passageway to be gated by the safety gate, and a safety bar pivotally connected to the bracket such that the safety bar can pivot between a closed position, wherein the safety bar is substantially horizontal to obstruct the passageway, and an open position, wherein the safety bar is substantially vertical to permit unobstructed passage through the passageway. The safety bar can be adjustable in length to fit various passageways, stairwells or doorways of different widths. The safety gate may also include a lockable spring-loaded pneumatic cylinder to enhance the motion characteristics of the safety bar when raised and lowered, and to enable a user to lock the safety bar in any desired posture.

### CROSS-REFERENCE TO RELATED APPLICATIONS

The application is claims priority under 35 U.S.C. § 119(e), of U.S. Provisional Patent Application Ser. No. 61/046,084 entitled SAFETY GATE filed on Apr. 18, 2008.

### TECHNICAL FIELD

The present invention relates generally to safety gates and, in particular, to safety gates for the visually impaired.

### BACKGROUND OF THE INVENTION

There exist a wide range of safety gates for keeping babies or infants from falling down stairs or for keeping family pets out of certain areas of the home. These safety gates are typically installed at the top of a staircase or in the doorway or passageway between two adjoining rooms. These safety gates usually have a swivel or hinge mechanism anchored to one wall (or one side of a doorframe) to enable the gate to swing open. Other than swiveling safety gates, there are also sliding gates, extensible/retractable mesh gates and collapsible (accordion-style) gates, to name but a few of the main types. Typically, these gates have some sort of closing or locking mechanism to hold or secure the gate in the closed position. The closing mechanism is often affixed to the opposite wall or opposite side of the doorframe, as is well known in the art. A variety of childproof locking mechanisms exist for ensuring that only adults can unlock and operate the gate. Some illustrative examples of safety gates are found in U.S. Pat. No. 6,711,857 entitled “Infant Safety Gate With Remote Latch Activating Mechanism”, U.S. Pat. No. 6,470,948 entitled “Safety Gate”, U.S. Pat. No. 6,112,461 entitled “Safety Gate for Children”, U.S. Pat. No. 5,927,011 entitled “Child and Pet Safety Gate”, U.S. Pat. No. 4,787,174 entitled “Child Safety Gate”, and U.S. Pat. No. 4,777,765 entitled “Adjustable Width Doorway Safety Gate Apparatus.”

There are also a number of safety gates designed, not for domestic usage, but rather for industrial safety applications such as, for example, the safety gates shown in U.S. Pat. No. 6,412,220 entitled “Upright Rotatable Arcuate Safety Gate for a Mezzanine Loading Bay” and in U.S. Pat. No. 5,459,963 entitled “Safety Gate for Loading Docks.” These safety gates are used to prevent workplace injuries, e.g. preventing workers from falling off platforms or the like.

Although there exist a wide range of safety gates, none of these prior-art safety gates are particularly well-adapted for elderly adults or for the visually impaired. The prior-art gates, such as for example the various child-safety gates known in the art, are generally-speaking ill-suited for use by visually impaired or elderly adults with restricted mobility. For example, gates that swing open like a door require the user to manoeuvre around the gate as it is opened, which can be difficult for a person with a cane or a walker. Traditional child-safety gates, which are often low, can be potentially dangerous for visually impaired adults or adults with restricted mobility. If a person inadvertently steps backward or stumbles backward into the gate, the person may topple right over the gate. For persons living with pets, such as cats or dogs, these gates can be quite inconvenient as they block the passage for the pet. Accordingly, an improved safety gate that is simple, inexpensive and easy to operate would be highly desirable.

### SUMMARY OF THE INVENTION

In accordance with a main aspect of the present invention, a safety gate includes an anchoring bracket for anchoring the safety gate to an immovable structure adjacent to a passageway to be gated by the safety gate and a safety bar pivotally connected to the bracket such that the safety bar can pivot between a closed position, wherein the safety bar is substantially horizontal to obstruct the passageway, and an open position, wherein the safety bar is substantially vertical to permit unobstructed passage through the passageway.

In one embodiment, the safety bar is adjustable in length. For example, the safety bar can be a telescopically adjustable safety bar comprising an elongated hollow structure having a first end pivotally connected to the bracket and a second end having an opening through which an internally sliding bar can be slid to adjust an overall length of the safety bar.

In another embodiment, the safety gate further comprises a spring-loaded pneumatic cylinder connected to an underside of the safety bar for exerting a retracting force on the safety bar when the safety bar is raised until the safety bar is locked into the open position, the pneumatic cylinder furthermore acting as a damper to dampen downward movement of the safety bar when the safety bar is released from the open position and falls downwardly back into the closed position. This spring-loaded cylinder may optionally include a lock or locking mechanism to lock the cylinder in the opened position, for example, or in any other desired posture.

This novel safety gate is simple, inexpensive to manufacture and easy to operate. This safety gate can be used in a variety of applications, for example, at home, at retirement residences, hospitals, etc. This safety gate is particularly useful for adults, specifically the elderly, those with restricted mobility or those who are visually impaired. The safety gate can be easily raised or lowered with one hand, which is very useful for persons who utilize a cane or a walker, or even for a person who prefers to hold onto the banister or railing when coming up a staircase. This safety gate can prevent individuals from falling down stairwells, which is a common cause of serious injury and even death among the elderly.

### BRIEF DESCRIPTION OF THE DRAWINGS

Further features and advantages of the present technology will become apparent from the following detailed description, taken in combination with the appended drawings, in which:

FIG. 1 is a side elevational view of the safety gate in accordance with one embodiment of the present invention, showing the safety gate in a closed (lowered) position;

FIG. 2 is a side elevational view of the same safety gate as was shown in FIG. 1 but now illustrated in an open (raised) position;

FIG. 3 is an exploded view of the same safety gate as was depicted in FIGS. 1 and 2;

FIG. 4 is a side elevational view of the safety gate of FIG. 1, showing the safety bar adjusted in length for different passageways;

FIG. 5 is a partial perspective view of a spring-loaded pneumatic cylinder with a locking clip, employed in the safety gate of FIG. 3; and

FIG. 6 is a partial side elevational view of the spring-loaded pneumatic cylinder with the locking clip, showing the locking clip in an engaging position and in a disengaging position (as shown in broken lines).

It will be noted that throughout the appended drawings, like features are identified by like reference numerals.

### DETAILED DESCRIPTION OF THE PREFERRED EMBODIMENTS

The present invention will now be described in detail with reference to a number of illustrative embodiments.

In general, the novel safety gate that is disclosed herein includes an anchoring bracket for anchoring the safety gate to an immovable structure adjacent to a passageway to be gated by the safety gate. In other words, the anchoring bracket enables the safety gate to be mounted to a wall, doorframe or other immovable structure. This novel safety gate also includes a safety bar pivotally connected to the bracket such that the safety bar can pivot between a closed position, wherein the safety bar is substantially horizontal to obstruct the passageway, and an open position, wherein the safety bar is substantially vertical to permit unobstructed passage through the passageway. Thus, this novel safety gate has a pivotally mounted safety bar that can be raised and lowered to either permit passage of the user through a given passageway or to block the user from passing through the passageway. For example, when mounted at the top of a stairwell, this novel safety gate helps to prevent accidental falls down the stairs. This safety gate can thus be very useful in preventing serious injury or even death.

The preferred embodiments of the present invention will now be described below, by way of example, with reference to the attached drawings.

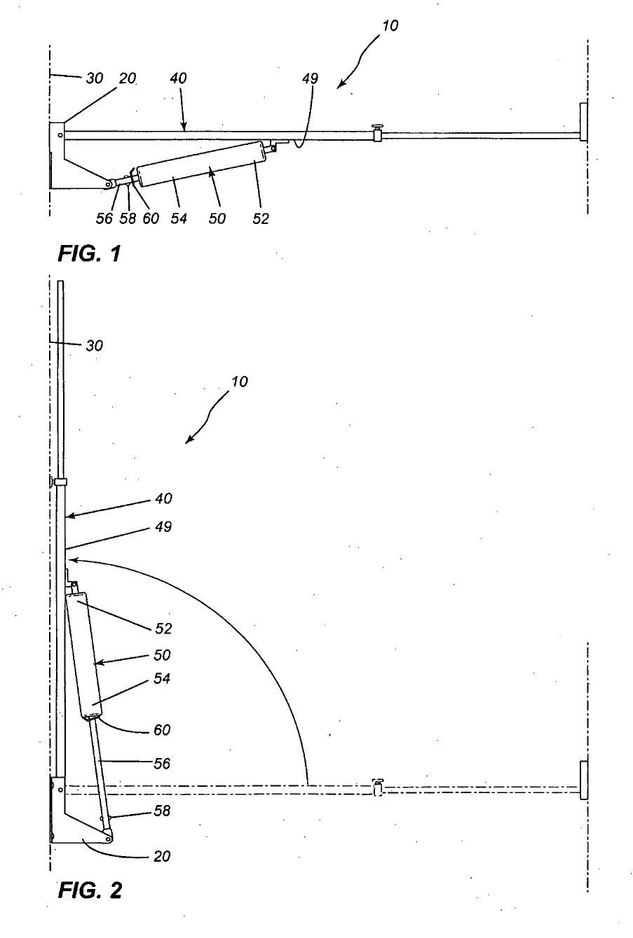

FIG. 1 is a side elevational view of the safety gate in accordance with one embodiment of the present invention. This figure depicts the safety gate in a closed (or lowered) position. In this position (or posture), the gate is meant to block off, or prevent access to, a passageway, a stairwell or other area. As depicted in FIG. 1, the safety gate, which is designated generally by reference numeral 10, includes an anchoring bracket 20 for anchoring the safety gate to an immovable structure 30 adjacent to a passageway to be gated by the safety gate, such as, for example, the top of a staircase. The safety gate 10 also includes a safety bar 40 pivotally connected to the anchoring bracket 20 such that the safety bar 40 can pivot between a closed position, wherein the safety bar 40 is substantially horizontal to obstruct the passageway, and an open position, wherein the safety bar 40 is substantially vertical to permit unobstructed passage through the passageway.

FIG. 2 is a side elevational view of the same safety gate 10 as was shown in FIG. 1 but now illustrated in an open (raised) position. In this position, the safety bar 40 is raised up, preferably to a substantially vertical posture, to enable a person to pass through the passageway or to enter the stairwell. It will be appreciated that the safety bar 40 of this gate may be raised to virtually any desired posture and locked in place by virtue of a locking mechanism that will be explained in greater detail below. In one particular embodiment, the safety bar is raised to a generally upright posture that actually pivots the safety bar through more than ninety (90) degrees so that the safety bar is safely locked into the open (raised) position.

FIG. 3 is an exploded view of the same safety gate 10 as was depicted in FIGS. 1 and 2.

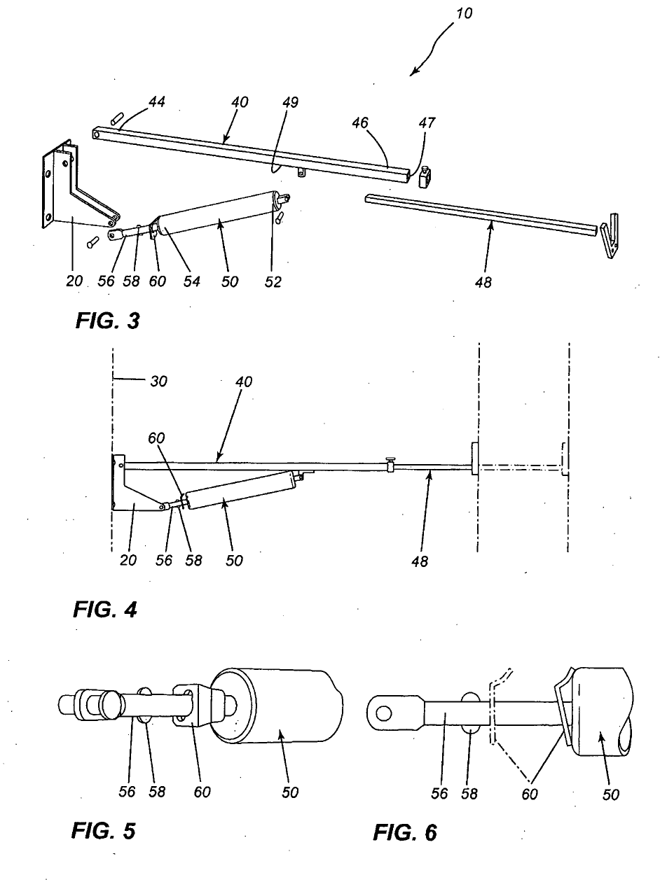

As illustrated in FIG. 4, the safety bar 40 can be adjustable in length to fit various passageways, stairwells or doorways of different widths. In one particular embodiment, the safety bar 40 is a telescopically adjustable safety bar comprising an elongated hollow structure 42 having a first end 44 pivotally connected to the anchoring bracket 20 and a second end 46 having an opening 47 through which an internally sliding bar 48 can be slid to adjust an overall length of the safety bar 40.

As shown in FIGS. 3 and 5-6, the safety gate may also include a lockable spring-loaded pneumatic cylinder to enhance the motion characteristics of the safety bar when raised and lowered, and to enable a user to lock the safety bar in any desired posture. A spring-loaded pneumatic cylinder 50 is connected to an underside 49 of the safety bar 40 for exerting a retracting force on the safety bar 40 when the safety bar 40 is raised until the safety bar 40 is locked into the open position, the pneumatic cylinder 50 furthermore acting as a damper to dampen downward movement of the safety bar when the safety bar is released from the open position and falls downwardly back into the closed position.

In one specific embodiment, the safety gate 10 comprises a locking clip 60 for locking the spring-loaded pneumatic cylinder 50 in place to thereby immobilize the safety bar 40 in any desired posture. The locking clip 60 has an odd-shaped opening to permit the locking clip to slide over a rod 56 extending from the pneumatic cylinder. The rod 56 further comprises a pair of notches (protuberances) 58 that protrude orthogonally from the opposite sides of the rod. The odd-shaped opening in the locking clip 60 must be aligned with the notches 58 on the rod to slide the locking clip past these notches 58. As a result, the notches ensure that the locking clip does not engage unintentionally.

As shown in the specific embodiment illustrated in FIG. 1 and FIG. 2, the spring-loaded pneumatic cylinder 50 has a first end 52 pivotally connected to the underside 49 of the safety bar 40 and a second end 54 pivotally connected to the anchoring bracket 20 to which the safety bar 40 is also pivotally connected. As will be appreciated by those of ordinary skill in the mechanical arts, the first end 52 of the cylinder 50 is pivotally connected to the underside 49 of the safety bar 40 at approximately a midpoint of the safety bar. By varying this pivotal connection point, the kinematics of the safety gate can be optimized so that the gate is easy to raise and lower. Likewise, the motion characteristics of the safety gate can be adjusted by using a spring-loaded pneumatic cylinder that has an adjustable damper. For example, this safety gate can incorporate a pneumatic cylinder with an adjustable damper such as the one disclosed in U.S. Pat. No. 4,707,882 (Watts) entitled “Pneumatic damper”, which is hereby incorporated by reference. As set forth in this patent, this pneumatic damper, which was designed primarily for use as a door closer, comprises a cylinder closed at one end having a piston axially slidable therein to define a pressurizable chamber between the piston and the closed end of the cylinder. The piston has a mechanism to allow air to flow past the piston when the piston slides axially away from the closed end and to prevent airflow past the piston as the piston moves towards the closed end. An elongated arm is secured to the piston to extend out of the cylinder, the arm being displaceable to cause the piston to slide within the cylinder. An adjustable airflow control is provided on the wall of the cylinder at a selected position to allow variation of airflow between the piston and cylinder wall at the selected position to cause, in use, a sudden reduction in the air pressure within the chamber. Another adjustable damper is disclosed in U.S. Pat. No. 4,382,311 (Watts) entitled “Door-Closure Apparatus” which is also hereby incorporated by reference. This second Watts patent discloses a pneumatic door-closure apparatus comprising an elongated cylindrical housing in which an integrally formed rod and piston are slidably biased. The rod has a free end that extends outwardly therefrom and includes a plurality of transversely disposed grooves to receive an adjustable-retainer clamp, so as to regulate the inward longitudinal movement of the piston. The rear closed end of the housing is provided with an air-valve regulator to control the speed of the inward movement of the piston, the piston including an airflow control to allow air to pass freely from the spring-biased side of the piston to the compressed-air side, when the rod is extended outwardly from the housing. A two-way-mounting bracket is further provided and arranged to be attached at the rear closed end of the cylindrical housing for right or left hand mounting of the apparatus. Accordingly, it should be appreciated that adjustable damping may be used in this novel safety gate to enable the user of the gate to adjust the motion characteristics of the gate to his or her liking.

This novel safety gate 10 can be adapted for use in a variety of environments, such as, for example, in a house at the top of the stairs, in a hospital, in a retirement residence, etc. This safety gate is designed to enable its pivotal safety bar to be raised and lowered easily and with a single hand. This is particularly useful for persons who walk with a cane or walker or who prefer to hold onto a banister or railing. Because the safety gate has a safety bar rather than a half door as do most child safety gates, it will not cause adults to topple over the gate, nor will it block pets such as cats and dogs from coming up the stairs. Also, since the gate bar pivots up and down rather than swinging open, this safety gate is much easier to operate for a person with restricted mobility. In other words, it is much easier to pass through the gated passageway by simply raising the safety bar rather than having to manoeuvre around the gate as it swings open. As a further benefit, the novel safety gate is more compact than most of the commercially available safety gate, which employ cumbersome mounting brackets for holding the heavy swinging gates. As yet a further benefit, the novel safety gate

The embodiments of the invention described above are intended to be exemplary only. As will be appreciated by those of ordinary skill in the art, to whom this specification is addressed, many obvious variations can be made to the embodiments present herein without departing from the spirit and scope of the invention. The scope of the exclusive right sought by the applicant is therefore intended to be limited solely by the appended claims.

I/We claim:

1. A safety gate comprising:
an anchoring bracket for anchoring the safety gate to an immovable structure adjacent to a passageway to be gated by the safety gate; and
a safety bar pivotally connected to the bracket such that the safety bar can pivot between a closed position, wherein the safety bar is substantially horizontal to obstruct the passageway, and an open position, wherein the safety bar is substantially vertical to permit unobstructed passage through the passageway.

2. The safety gate as claimed in claim 1 wherein the safety bar is adjustable in length.

3. The safety gate as claimed in claim 1 wherein the safety bar is a telescopically adjustable safety bar comprising an elongated hollow structure having a first end pivotally connected to the bracket and a second end having an opening through which an internally sliding bar can be slid to adjust an overall length of the safety bar.

4. The safety gate as claimed in claim 1 further comprising a spring-loaded pneumatic cylinder connected to an underside of the safety bar for exerting a retracting force on the safety bar when the safety bar is raised until the safety bar is locked into the open position, the pneumatic cylinder furthermore acting as a damper to dampen downward movement of the safety bar when the safety bar is released from the open position and falls downwardly back into the closed position.

5. The safety gate as claimed in claim 2 further comprising a spring-loaded pneumatic cylinder connected to an underside of the safety bar for exerting a retracting force on the safety bar when the safety bar is raised until the safety bar is locked into the open position, the pneumatic cylinder furthermore acting as a damper to dampen downward movement of the safety bar when the safety bar is released from the open position and falls downwardly back into the closed position.

6. The safety gate as claimed in claim 3 further comprising a spring-loaded pneumatic cylinder connected to an underside of the safety bar for exerting a retracting force on the safety bar when the safety bar is raised until the safety bar is locked into the open position, the pneumatic cylinder furthermore acting as a damper to dampen downward movement of the safety bar when the safety bar is released from the open position and falls downwardly back into the closed position.

7. The safety gate as claimed in claim 4 further comprising a locking clip for locking the spring-loaded pneumatic cylinder to thereby immobilize the safety bar in any desired posture.

8. The safety gate as claimed in claim 5 further comprising a locking clip for locking the spring-loaded pneumatic cylinder to thereby immobilize the safety bar in any desired posture.

9. The safety gate as claimed in claim 6 further comprising a locking clip for locking the spring-loaded pneumatic cylinder to thereby immobilize the safety bar in any desired posture.

10. The safety gate as claimed in claim 6 wherein the cylinder has a first end pivotally connected to the underside of the safety bar and a second end pivotally connected to the anchoring bracket to which the safety bar is also pivotally connected.

11. The safety gate as claimed in claim 10 wherein the first end of the cylinder is pivotally connected to the underside of the safety bar at approximately a midpoint of the safety bar.

12. The safety gate as claimed in claim 1 wherein the pneumatic cylinder has an adjustable damper to adjust the damping characteristics of the safety bar when the safety bar is released downwardly from the open position to the closed position.
